(19) United States
(12) Patent Application Publication
(10) Pub. No.: US 2026/0341002 A1
(43) Pub. Date: Oct. 29, 2026

(54) METHOD FOR REDUCING HALLUCINATIONS IN VISION-LANGUAGE MODELS

(71) Applicant: SAMSUNG ELECTRONICS CO., LTD., Suwon-si (KR)

(72) Inventors: Yassine OUALI, Middlesex (GB); Adrian BULAT, Middlesex (GB); Georgios TZIMIROPOULOS, Middlesex (GB); Brais Martinez ALONSO, Middlesex (GB)

(21) Appl. No.: 19/712,429

(22) Filed: Jun. 18, 2026

Related U.S. Application Data
(63) Continuation of application No. PCT/KR2025/003033, filed on Mar. 7, 2025.

(30) Foreign Application Priority Data
Mar. 7, 2024 (GR) 20240100165
Mar. 5, 2025 (GB) 2503176.6

(51) Int. Cl. G06V 10/774; G06V 10/764; G06V 10/776; G06V 10/82

(52) U.S. Cl. CPC G06V 10/774; G06V 10/764; G06V 10/776; G06V 10/82

(57) ABSTRACT

Broadly speaking, embodiments of the present techniques provide a method for reducing hallucinations in the outputs of vision-language, VL, machine learning, ML, models. In particular, the present application provides a method for generating a training dataset for fine-tuning a pre-trained vision-language model such as large vision language models, LVLMs, so that the outputs of the LVLMs have fewer hallucinations. Advantageously, this training dataset is generated using some or all of the images used to train the pre-trained vision-language ML model in the first place, which means no additional training images are required. Each image in the training dataset comprises two captions-a positive caption (or label) and a negative caption (or label). The goal is to fine-tune the pre-trained VL ML model using this training dataset such that the model learns to produce outputs that are more like the positive captions and less like the negative captions.

### CROSS-REFERENCE TO RELATED APPLICATIONS

This application is a continuation of International Application No. PCT/KR2025/003033, filed on Mar. 7, 2025, in the Korean Intellectual Property Receiving Office, which is based on and claims priority to GB patent application No. GR20240100165, filed on Mar. 7, 2024 and GB patent application No. GB2503176.6, filed on Mar. 5, 2025 in UK Intellectual Property Office, the disclosures of which are incorporated by reference herein in their entireties.

### BACKGROUND

### 1. Field

The present application generally relates to a method and apparatus for reducing hallucinations in the outputs of large vision-language, VL, machine learning, ML, models. In particular, the present application provides a method for generating a training dataset for fine-tuning a pre-trained vision-language model such as large vision language models, LVLMs, so that the outputs of the LVLMs have fewer hallucinations.

### 2. Description of Related Art

A Large Vision Language Model (LVLM) is a Large Language Model (LLM) combined with an independently-trained large vision encoder, typically taken from VL embedding models like CLIP and kept frozen. LVLMs have recently become the state-of-the-art for vision language understanding. Unlike prior generation of models which were typically tuned for one, or a small number of tasks, LVLMs allow free form dialog in natural language with an image in-the-loop. This direction largely draws inspiration from the recent success of ChatGPT, and respectively ChatGPT-4V that adapt LLMs to follow human instruction and preferences via various form of reinforcement learning from human feedback (RFLH) and/or supervised finetuning (SFT) on a high-quality multi-turn instruction (i.e. chat) data. In a similar fashion, the current generation of LVLMs are trained as part of a two-step process. First, the CLIP vision encoder is aligned with the LLM by training a few adaptation layers only and, then, by fine-tuning the model using SFT on a multi-modal instructional dataset. Despite their remarkable success, a major limitation hindering the wider adoption of LVLMs is the high rate of hallucinated details (e.g. non-existing objects) that these models exhibit in their generated output text. Following the footsteps of LLM training, a natural solution to combat hallucinations is given by RFLH.

As reinforcement learning based-training is generally expensive, often requiring the training of a policy model, very recently a simplified framework was proposed—Direct Preference Optimisation (DPO)—that allows direct training using a binary cross-entropy objective. The data for DPO is typically obtained either directly from human preferences or using a LLM to automatically construct preference data. Thanks to its efficiency, DPO has been quickly adopted for LVLMs too. However, these approaches require multiple LVLMs for labeling, the collection of additional data, and the usage of a GPT-4/GPT-4V API for label ranking. Moreover, the GPT-4 provided scores are discrete (hence, of reduced granularity) and are themselves prone to hallucinations, which can perpetuate and exacerbate the already high rate of factual errors and poor image grounding. Finally, GPT-4/V is behind a paywall, and using it for data construction is neither scalable nor cost-efficient.

The applicant has therefore identified the need for improved techniques for training, fine-tuning or adapting vision-language models.

### SUMMARY

In a first approach of the present techniques, there is provided a computer-implemented method for generating a training dataset for fine-tuning a first pre-trained large vision-language model (LVLM) to generate accurate text captions, the method comprising: obtaining a plurality of images; for each image of the plurality of images: inputting the image into a second pre-trained large vision-language model (LVLM) that is pre-trained to output text captions for images; obtaining a plurality of text captions for the image from the second pre-trained large vision-language model together with a score for each text caption that indicates a similarity between the input image and the text caption, wherein a higher score means the text caption more accurately describes the image; ranking the obtained plurality of text captions using the scores; selecting, from the ranking, a pair of text captions comprising the most accurate text caption and the least accurate text caption; assigning the selected most accurate text caption as a positive label for the image and assigning the selected least accurate text caption as a negative label for the image; and adding the image and the assigned positive and negative labels to a database of images with pairs of labels, the database forming the training dataset.

Advantageously, the present techniques lead to a more accurate trained vision-language model which can generate more targeted or focused image captions for (or answers to questions about) input images. This is useful because generally, vision-language models may have been trained on very large datasets generated by humans with a wide variety of goals, priorities and skillsets, and it is desirable to steer already-trained vision-language models towards specific human preferences. These preferences could be of an administrator who is re-training or customising already-trained vision-language models for a customer base, or the preferences could of individuals/end users who want already-trained vision-language models to output results that are more suitable for them and their needs.

Further advantageously, the present techniques remove or minimise hallucinations in the responses/outputs generated by vision-language models. A hallucination is a response generated by an artificial intelligence or ML model that contains false or misleading information presented as fact. This is particularly problematic in chat-bots powered by such models, which may embed plausible-sounding false information within their generated content. Hallucinations may manifest as incorrect captions or descriptions of images, and/or as incorrect answers to questions asked about the image.

Vision-language models are multi-modal models which can process and link information from multiple types of input source, such as images, videos, text, audio, and so on. That is, vision-language models combine vision and language modalities (i.e. perform image processing and natural language processing), and are able to perform tasks such as image captioning, text-guided image generation and editing, and visual question-answering.

The present techniques tackle the hallucination problem by fine-tuning a pre-trained vision-language ML model using a specially-designed training dataset. Advantageously, this training dataset is generated using some or all of the images used to train the pre-trained large vision-language model in the first place, which means no additional training images are required. However, the training dataset contains additional text captions that are designed to reduce the number of hallucinations in text (written or ‘spoken’) answers in response to queries about the images. Each image in the training dataset comprises two captions-a positive caption (or label) and a negative caption (or label). The positive caption is an accurate text caption for the image (or an accurate/true text answer to a question about the image), while the negative caption is an inaccurate but plausible text caption for the image (or an inaccurate/false but plausible text answer to a question about the image). The negative captions may be considered to contain hallucinations. The goal is to fine-tune the pre-trained large vision-language model using this training dataset such that the model learns to produce outputs that are more like the positive captions and less like the negative captions. In other words, by showing the pre-trained large vision-language model both the positive and negative captions, the model should produce outputs that contain fewer hallucinations. As a result, chat-bots or other AI assistants that are powered by such a model will produce better outputs.

Thus, the step of obtaining a plurality of images may comprise obtaining some or all of the images used to pre-train the first pre-trained large vision-language model.

As noted above, for each image, a second pre-trained large vision-language model is used to generate a plurality of text captions. That is, for each image, multiple text captions are generated. More information on how these text captions are generated for each image is provided below.

Once the plurality of text captions are obtained for each image, it is necessary to determine which of the text captions should be used as the positive and negative captions for the image. This may be done by ranking the plurality of text captions. As noted above, each text caption is associated with a score. More information on how this score is generated is provided below. This score can be used to rank the text captions for each image.

An embedding is a representation of values or objects, like text, images or audio, that can be understood and processed by machine learning models. An embedding usually takes the form of a vector, and thus the terms “embedding” and “embedding vector” are used interchangeably herein. An embedding is therefore a mathematical representation of a data item (e.g. text, image, video, audio, etc.), and may represent some or all of the content of the data item. For example, an embedding may represent the semantic meaning of an image or a text caption of an image. Embeddings make it possible for machine learning models to understand the relationships between different data items, such as between images and text captions. Embeddings are normally analysed within embedding space, i.e. a mathematical space in which similar items are positioned closer to one another than less similar items. For example, if embedding A for data item A is close to embedding B for data item B in embedding space, then data item A and data item B are similar in some way.

The ranking of the obtained plurality of text captions may comprise: determining an image embedding vector for the image, and a text embedding vector for each text caption; and calculating the score for each text caption by determining a similarity between the image embedding vector and the text embedding vector for the text caption. In this way, the image and text captions can be compared more easily, because each is reduced to an embedding that can be compared mathematically.

Calculating a score for each text caption may comprise determining a cosine similarity between the image embedding vector and the text embedding vector for the text caption. Cosine similarity is a measure of the similarity between two vectors, and is calculated by determining the cosine of the angle θ between the two vectors. When θ is close to 0°, cosine θ is close to 1, which means the vectors are similar; when θ is close to 90°, cosine θ is close to 0, which means the vectors are orthogonal; and when θ is close to 180°, cosine θ is close to −1 which means the vectors are opposite. Note that contrastive models used to determine cosine similarity are usually trained to determine a value between 0 and 1. That is, these models ask whether a pair of inputs are similar or not. This means that when a pair of inputs (vectors) are opposite, the contrastive model will likely give them a low score (close to zero) rather than a negative score. In any case, the cosine similarity may be used to determine how similar each image is to the text caption generated for the image.

There may be multiple ways to calculate the score for each text caption. One way involves using a contrastively pre-trained vision-language model. One example of a contrastively pre-trained vision-language model is CLIP (contrastive language-image pre-training), which is a neural network that has been trained on a variety of (image, text) pairs. Thus, the image and the plurality of text captions generated for the image (or their embeddings) may be input into a separate CLIP model to be scored. CLIP provide a score between 0 and 1 between a text caption and an image—the higher the score, the more similar the image and text caption are. The CLIP model does not assess whether the text captions contain hallucinations or inaccuracies—it only compares the inputs and provides a similarity score. However, it has been found that the higher the similarity score, the fewer the hallucinations in the text captions, which makes the score a good way to rank the generated text captions. It will be understood that any vision-language model capable of providing a similarity score between an image-text caption pair (or their embeddings) can be used as the model that performs the scoring and ranking and CLIP is just one example.

There may be at least two ways to obtaining the plurality of text captions for an image. One way is to generate generic captions for an image, which are general descriptions of the content of the image. For example, a generic caption for an image may say “The image shows a man wearing a suit. He is sitting on steps, and checking his watch”. Another way is to start from a generic caption and then use this to generate image-specific/per-image questions and answers, which are questions and answers specific to the image. For example, the generic caption above may lead to a question for an image being “Is the man wearing jeans?” and the answer being “No, he is wearing a business suit”. These two ways are now described in turn. The present techniques use one or both of these two ways. In some cases, some or all generic captions are used to generate image-specific captions (per-image questions and answers).

Generic captions: One example way to obtain the plurality of text captions for an image may comprise inputting at least two pre-defined caption prompts into the second pre-trained vision-language ML model together with the image, wherein the at least two pre-defined prompts cause the pre-trained vision-language ML model to generate the plurality of text captions for the image. That is, in order to generate generic captions, each image and at least two pre-defined caption prompts are input into the second pre-trained vision-language model. Two or more pre-defined caption prompts may be used to generate the plurality of text captions. In some cases, one prompt leads to one text caption. That is, the model generates different descriptions of the same image when provided with different prompts that elicit different behaviours in the model during the text caption generation. In other cases, it may be possible for one prompt to lead to more than one text caption.

Specific, per-image captions: Another example way to obtain the plurality of text captions for an image may comprise inputting at least one pre-defined caption prompt into the pre-trained vision-language ML model together with the image, wherein the at least one pre-defined caption prompt causes the pre-trained vision-language ML model to generate at least one text caption for the image. That is, the per-image captions are generated by first generating at least one generic caption for each image.

For the per-image captions, each generic caption is then parsed by a large language model, LLM, into a question, a positive/correct answer and a negative/incorrect answer. Thus, the method further comprises: inputting the generated at least one text caption into a large language model, LLM together with a pre-defined question-answer prompt to generate at least one question with two corresponding answers; obtaining, from the LLM, at least one question with two corresponding answers; and using the obtained answers as the plurality of text captions for the image. LLMs may be the most suitable models for this step, since it is a language processing and conversion step that takes a detailed caption and a prompt that asks the LLM to generate a question, a positive answer, and a negative answer.

The step of obtaining, from the LLM, at least one question and two corresponding answers may comprise, for each text caption inputted into the LLM: obtaining a positive answer to the question generated by the LLM, wherein the positive answer is a correct answer to the question; and obtaining a negative answer to the question generated by the LLM, wherein the negative answer is an incorrect answer to the question.

Generally speaking, not every text caption, or question and answers, is useful for forming the training dataset. An example of a good pair of text captions is one where the accurate/positive text caption for an image is “The image shows a man wearing a business suit” and the inaccurate/negative text caption for the image is “The image shows a woman wearing a business suit”. This could help correct hallucinations that occur when describing images of people wearing suits-sometimes, models erroneously assume that someone wearing a suit must be male, for example. In contrast, less useful pairs of text captions may be those that are “too easy” to understand. For instance, “The image shows a cat” and “The image does not show a cat” is an example of a pair of text captions that are too easy. Similarly, some pairs of text captions may not be less useful if the text captions have differing accuracy or description quality or length. For instance, one text caption for an image may be “The image shows a man wearing a business suit”, and another text caption for the same image may be “The image shows a man sitting on a bench”. This pair of text captions may not be useful because the former text caption may be a better description of the image (and have a higher score) than the latter text caption, even though both are correct. Using the former text caption as the positive caption and the latter text caption as the negative caption would create erroneous results as both are correct descriptions. Thus, pairs of images like this are not useful either.

Thus, it may be desirable to filter out possible pairs of text captions that are not useful for forming the training dataset, so that they cannot be selected. There may be two ways to filter out the possible pairs of text captions: global filtering, which involves filtering/rejecting images and text captions that are deemed to be of low quality, and pair filtering, which involves filtering per-image text caption pairs that are not useful. These two ways are now described in turn. The present techniques use one or both of these two ways. In some cases, the global filtering may be performed before the pair filtering is performed.

Global filtering: One type of global filtering may comprise performing some image filtering after obtaining the plurality of images. This may be useful because the plurality of images may not all be useful. For example, it may be useful to ensure the images used to generate the training dataset are diverse, which may involve not having too many images that are similar to one another, or having too many images that show a certain object or scene.

To down-sample or reduce the number of images, after ranking the obtained plurality of text captions and prior to the selecting, the method may further comprise: obtaining a plurality of pre-defined class prototypes, each class prototype representing a type of image content, and each class prototype having a text embedding vector; and discarding any text caption and the image associated with the text caption when the text caption is dissimilar to any of the class prototypes. The pre-defined class prototypes may be generated for generic categories of image content, for example, “text”, “people”, “objects”, and “scenes”. It will be understood that these are example, non-limiting possible categories. For each category, a plurality of text descriptions are generated, which explain what images in the categories may contain. These are then used to create a single class prototype for each category, the prototype comprising a text embedding vector. The class prototypes are used to filter out/discard any text captions, and their associated images, which do not fit in with or suitably match any of the prototypes.

The discarding comprises, for each text caption: calculating a text embedding vector for the text caption; calculating a similarity score between the text embedding vector for the text caption and the text embedding vector of each class prototype; determining, using the calculated similarity score, one class prototype from the obtained plurality of pre-defined class prototypes that best matches the text caption; and discarding the text caption and the image associated with the text caption when the similarity score is below a pre-defined threshold similarity score for the class prototype. Thus, each class prototype may be associated with a pre-defined threshold similarity score. In some cases, all of the class prototypes may be associated with the same pre-defined threshold similarity score. When the similarity score between a text caption and the best-matching class prototype is below the threshold similarity score, the text caption is not considered to be useful or good enough to form part of the final training dataset. In this way, text captions, and their associated images, are discarded.

Another type of global filtering comprises filtering all generic captions that have a score below a certain pre-defined score. This may indicate that the text caption is not very good or even plausible for the image. It is desirable for the negative text captions to be plausible and not obviously wrong. For example, for an image showing a man in a business suit in an office, a caption that says “a mountain scene” is clearly wrong and not even plausible for the image. This is not a useful text caption to use as a positive or negative text caption. Thus, after ranking the obtained plurality of text captions and prior to the selecting, the method may further comprise: discarding any text caption having a score below a pre-defined threshold score. For example, all generic text captions having a CLIP score below 28.0 may be discarded.

Another type of global filtering may be performed after ranking the obtained plurality of text captions and prior to the selecting, and may further comprise: discarding any text caption having a length over a pre-defined text caption length. As CLIP may be used to perform the scoring of text captions, given that CLIP is trained mainly on short text, long captions are removed to make the CLIP scores more precise.

Pair filtering: here, pairs of text captions that are of low quality are filtered out. For each image, the step of selecting, from the ranking, the most accurate text caption and the least accurate text caption may comprise: forming pairs of text captions from the obtained plurality of text captions; and discarding each pair of text captions where the length of the text captions is different. This is useful because it avoids introducing false preferences (e.g. preferring short captions over longer ones) and encourages the focus to be on understanding the difference in the meaning of positive and negative captions.

The method may further comprise: determining, for each pair, whether a difference between scores for each text caption in the pair is above a pre-defined difference threshold indicating that the text captions in each pair are different; and selecting, the pair of text captions having the biggest difference between scores. This is useful because it ensures that the text captions are different enough to form a useful positive and negative pair. In other words, this is performed to avoid having a positive and negative pair which are both correct but only vary in the level of detail—it is preferable that the pair of captions differ in correctness.

Generally speaking, the first pre-trained large vision-language model and the second pre-trained large vision-language model may be the same model. That is, after the first pre-trained large vision-language model has been pre-trained, it may be used to generate the training dataset that will be used to perform its own fine-tuning.

Alternatively, the first pre-trained large vision-language model and the second pre-trained large vision-language model may be different, separate models. That is, a different large vision-language model may be used to generate the training dataset that will be used to perform the fine-tuning of the first pre-trained large vision-language model.

The first and second pre-trained large vision-language model may be or comprise one of the following architectures: MobileVLM-v2 and LLaVA-1.5. More generally, the first and second pre-trained large vision-language model may comprise a pre-trained CLIP vision encoder and a pre-trained LLM.

In a second approach of the present techniques, there is provided an apparatus for generating a training dataset for fine-tuning a first pre-trained large vision-language model to generate accurate text captions, the apparatus comprising: at least one processor coupled to memory, arranged for: obtaining a plurality of images; for each image of the plurality of images: inputting the image into a second pre-trained large vision-language model that is pre-trained to output text captions for images; obtaining a plurality of text captions for the image from the second pre-trained vision-language model together with a score for each text caption that indicates a similarity between the input image and the text caption, wherein a higher score means the text caption more accurately describes the image; ranking the obtained plurality of text captions using the scores; selecting, from the ranking, a pair of text captions comprising the most accurate text caption and the least accurate text caption; assigning the selected most accurate text caption as a positive label for the image and assigning the selected least accurate text caption as a negative label for the image; and adding the image and the assigned positive and negative labels to a database of images with pairs of labels, the database forming the training dataset.

In some cases, the training dataset generation method may be performed on a central server, and thus the apparatus may be a server. In other cases, the training dataset generation method may be performed on end-user devices. In such cases, the apparatus may be a constrained-resource device, but which has the minimum hardware capabilities to use a trained neural network/ML model. The apparatus may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge or smart vacuum cleaner). It will be understood that this is a non-exhaustive and non-limiting list of example apparatuses.

The features described above with respect to the first approach apply equally to the second approach and therefore, for the sake of conciseness, are not repeated.

In a third approach of the present techniques, there is provided a method of reducing hallucinations in vision-language, VL, machine learning, ML, models, the method comprising: obtaining a pre-trained large vision-language model; obtaining a training dataset generated using the methods described herein (e.g. with respect to the first approach); and further training the pre-trained large vision-language model using the obtained training dataset.

Further training the pre-trained large vision-language model may comprise: generating, for each image of the obtained training dataset, a positive label for the image and a negative label for the image; comparing the generated positive label and negative label with the assigned positive and negative labels of the image to generate a loss; and training the pre-trained large vision-language model to minimise the loss.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF DRAWINGS

Implementations of the present techniques will now be described, by way of example only, with reference to the accompanying drawings, in which:

FIG. 1 is a schematic diagram showing the CLIP-DPO idea of the present techniques;

FIG. 2 is a flowchart of example steps to generate a training dataset for fine-tuning a pre-trained large vision-language model to generate outputs with fewer hallucinations;

FIG. 3A is a flowchart showing the step to generate a generic caption;

FIG. 3B is a flowchart showing the step to generate a per-image caption;

FIG. 4 is a schematic block diagram showing the overall data generation process;

FIG. 5 shows examples of generated generic captions;

FIG. 6 is a schematic block diagram showing the filtering and pair generation process;

FIG. 7 shows an example of the question filtering procedure;

FIG. 8 shows examples of obtained pairs post-filtering;

FIG. 9 is a table showing hallucination evaluation results;

FIG. 10 is a table showing results of zero-shot image recognition experiments;

FIG. 11 is a table of results on several vision language tasks from the LlaVA benchmark;

FIG. 12 is a flowchart of example steps to train a pre-trained vision-language, VL model to produce outputs with fewer hallucinations; and

FIG. 13 is a block diagram of an apparatus 100 for generating a training dataset for fine-tuning a first pre-trained vision-language, VL, machine learning, ML, model.

### DETAILED DESCRIPTION

Broadly speaking, embodiments of the present techniques provide a method for reducing hallucinations in the outputs of vision-language, VL, machine learning, ML, models. In particular, the present application provides a method for generating a training dataset for fine-tuning a pre-trained vision-language model such as large vision language models, LVLMs, so that the outputs of the LVLMs have fewer hallucinations. Advantageously, this training dataset is generated using some or all of the images used to train the pre-trained vision-language ML model in the first place, which means no additional training images are required. Each image in the training dataset comprises two captions-a positive caption (or label) and a negative caption (or label). The goal is to fine-tune the pre-trained large vision-language model using this training dataset such that the model learns to produce outputs that are more like the positive captions and less like the negative captions.

The main idea behind the present techniques is to reduce/remove hallucinations and address the issues of current approaches related to the high cost of data construction. The present techniques propose a novel Direct Preference Optimisation, DPO, variant, called CLIP-DPO, that uses a pre-trained CLIP model to rank an LVLM's self-generated captions to construct positive-negative pairs for DPO. Since the CLIP model was trained in a contrastive manner to measure the alignment between image-text pairs, it is naturally suitable for determining the quality of a given output from an LVLM model, grounding it to the correct object or attribute. The dataset is constructed by running the original pre-trained target LVLM on its own output obtained using prompting, removing both the need of (i) additional external data and (ii) ensembles of external LVLMs. The final data is filtered prior to training using a newly introduced rule-based filtering.

Some existing techniques are now briefly described to help explain the present techniques.

Large Visual Language Models (LVLMs): Following the unprecedented success of Large Language Models (LLMs) recently, a series of works built multi-modal capabilities around them. Some of these works involve directly passing to a LLM the visual tokens produced by a pre-trained CLIP vision encoder, by either finetuning the LLM or adapting it using LoRA. Some of the works first reduce the number of vision tokens before passing them to an LLM. As the quality and distribution of the data plays a crucial role, a series of methods introduced improved data construction pipelines. For example, some techniques use the API of GPT-4V to first label, then train a model and finally re-annotate a new set using it. Despite their success, running and training such models is computationally demanding (e.g: LLAVA models have 7B and 13B parameters), hence, a recent line of works seeks to improve their efficiency by reducing the size of the models.

The present techniques are orthogonal to this direction and do not seek to change the model's architecture. Rather, the present techniques provide a new training approach based on DPO, referred to herein as “CLIP-DPO”.

Preference optimisation: While LLMs are strong few-shot learners and zero-shot performers, instruction tunning can significantly improve the perceived quality and usefulness by aligning the responses to a given task domain or human preferences. This is achieved either by direct finetuning on expert data or via reinforcement learning. The latter significantly simplifies the data collection process. Recently, a much simplified approach was proposed, Direct Preference Optimisation (DPO), which bypasses the need of training a reward model and allows direct training using a cross-entropy loss. Multiple improved versions for LLMs where proposed in the meantime. Following this, a recent wave of concurrent works on combining DPO with LVLMs were proposed. One of these constructs a multi-modal instructional dataset automatically labeled by GPT-4V. Similarly, another of these aims to reduce the rate of hallucinations uses a GPT4 model to label and construct positive-negative pairs exhibiting such cases of interest. One work follows a similar path by using a suite of LLMs and LVLMs to generate and label the data. These methods are then primarily evaluated on the LLaVA benchmark.

In contrast to the aforementioned works, the present techniques provide a novel DPO variant that uses a pre-trained CLIP model to rank the self-generated output of the trained LVLMs, thereby simplifying the process, removing the requirement of closed source paid APIs, removing the need for additional external LVLMs and improving the overall robustness of the model. Moreover, the present Applicant expands the evaluation benchmarks to include image captioning, object classification and hallucination assessment to better measure the precision, discriminability and robustness of the model.

Thus, the present techniques provide a novel DPO variant, called “CLIP-DPO”, that uses a pretrained CLIP model to rank the self-generated captions in order to construct positive-negative pairs for DPO. As the CLIP models were trained in a contrastive manner to measure the alignment between image-text pairs they are naturally suitable at determining the quality of a given output from a LVLM (large vision language model). The dataset itself over which the present techniques operate is constructed by running the pretrained target LVLM on its training set using prompting. The final data is filtered prior to training using a newly introduced rule-based filtering. The resulting model is trained on a wide array of datasets and benchmarks, on which it is shown that the present techniques significantly improve the discriminability, correctness and more importantly, reduce the amount of hallucinations, outperforming all LLaVA and LLaVA-like variants by a significant margin on zero-shot image captioning, classification and hallucination metrics.

LVLM hallucinations: Broadly speaking, in the context of LVLMs, hallucinations are considered to be incorrect or misleading generated text, contradicting the visual evidence provided by the input image. This is an undesirable characteristic inherited from the pre-trained LLM used, and further exacerbated by the visual-language alignment process. Multiple solutions have been recently proposed by the community with varying degrees of success. For example, some works attempt to address the data bias by constructing better-grounded annotated image-text pairs. Other works scale the resolution of the image encoder as this was observed to reduce the amount of hallucination, but at the cost of a high increase in the computational cost. Other works make improvements to the vision encoder by adding extra informational paths. One existing work (Zhao Z et al) constructs, with the help of GPT-4V, negative-positive pairs for DPO fine-tuning. The present techniques differ from this by using a pre-trained CLIP model to perform the ranking, and no additional data or external LVLMs are required. AMBER is used for evaluation purposes, which is the most comprehensive benchmark for hallucinations to date, encompassing both a generative and discriminative evaluation component. Importantly, unlike all prior benchmarks, AMBER is a high-quality dataset fully annotated by humans for both the generative and discriminative tasks.

Preliminaries: Let x be a multi-modal prompt consisting of an image and a text component and yᵢ the response generated by the π_{θ}(x) model when presented with the input x. The goal is to align the output yᵢ to a given preference starting from an initial pre-trained model. Traditionally, this was accomplished using reinforcement learning from human feedback (RFLH) based on reward models, that had to be trained prior to the reinforcement learning (RL) optimisation. Specifically, existing methods for fine-tuning language models with human feedback first fit a reward model to a dataset of prompts and human preferences over pairs of responses, and then use RL to find a policy that maximises the learned reward. Departing from this, DPO mitigates these issues by directly fine-tuning the model on the preference data. The main idea behind DPO is that the optimal policy π* has a closed-form solution with regard to a reward function r and initial policy π_{ref}:

$$r ( x , y ) = β \frac{{π}^{*} ( y \vert x )}{{π}_{ref} ( y \vert x )} + β log Z ( x ) ,$$

with Z the partition function. Under this framework the training objective can be written as:

$${max E}_{{π}_{θ}} ( x , {y}_{w} , {y}_{l} ) \sim {D}^{log σ ( β log \frac{{π}_{θ} ( {y}_{w} \vert x )}{{π}_{ref} ( {y}_{w} \vert x )} - β log \frac{{π}_{θ} ( {y}_{l} \vert x )}{{π}_{ref} ( {y}_{l} \vert x )} )} , \qquad ( 1 )$$

where y_{w} is the preferred, and yₗ the non-preferred response for x, and σ is the sigmoid function. In practice, the positive-negatives pairs for each input x are formed either by collecting true human preferences or using a LLM as a proxy to rank the answers produced by the model.

The present techniques—CLIP-DPO—are now described with reference to the Figures.

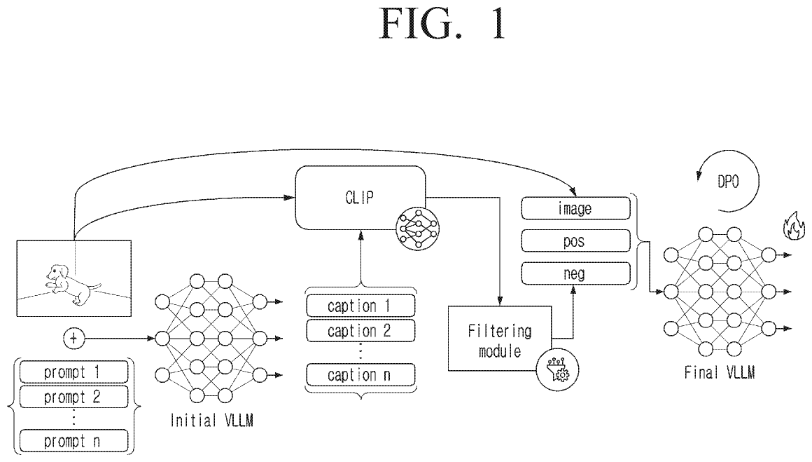

FIG. 1 is a schematic diagram showing the CLIP-DPO idea of the present techniques. The overall idea is to first self-generate multiple captions for an input image using a pre-trained vision language model (LVLM), and then filter those captions using a CLIP model in order to construct positive-negative pairs of captions for an input image. The positive-negative pairs of captions and the input image are then used to further train the LVLM.

As shown in FIG. 1, starting from a LVLM pre-trained on the LLaVA training set, by means of prompting, the present techniques use the LVLM on the training set to produce multiple captions, yᵢ, i∈{1, . . . , C} for each image in the training set. The training dataset comprises images and at least one text prompt associated with each image. Thus, as shown in FIG. 1, for each image in the training dataset there is at least one text prompt. Both the image and the at least one text prompt is input into the LVLM. The output of the LVLM is a plurality of captions.

To encourage a higher diversity, the output is sampled using beam search with a higher divergence penalty. Once completed, a pretrained vision-language CLIP model is used to score the relevance and/or accuracy of each output caption, in view of the input image and the at least one text prompt. The scoring is based on the cosine similarity, in embedding space, between text embeddings generated for each output caption (by the CLIP model) and visual embeddings generated for the image (by the CLIP model), relying on the vast information captured by the contrastively-pretrained CLIP model. This can be seen in FIG. 1, which shows the captions and input image being input into the CLIP model.

As not all captions output by the LVLM are suitable, a CLIP-based filtering strategy is introduced that removes unsuitable captions, and enforces a minimum and maximum margin between a positive and negative caption, where a positive caption is one which is relevant for the input image given the prompt(s), and a negative caption is one which is not relevant for the input image. This ensures that the remaining positive captions are likely to be accurate while the negative captions represent hard negatives. The filtering may be performed by a filtering module. As shown in FIG. 1, the output from the filtering module is a pair of positive and negative captions for the input image.

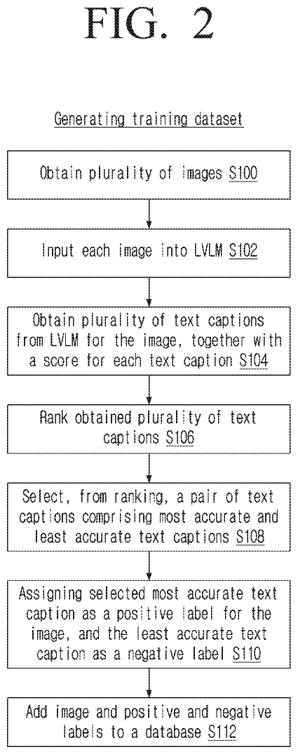

FIG. 2 is a flowchart of example steps to generate a training dataset for fine-tuning a pre-trained large vision-language model to generate outputs with fewer hallucinations. The steps of the method are computer-implemented method and comprise: obtaining a plurality of images (step S100); for each image of the plurality of images: inputting the image into a second pre-trained vision-language ML model that is pre-trained to output text captions for images (step S102); obtaining a plurality of text captions for the image from the pre-trained vision-language ML model together with a score for each text caption that indicates a similarity between the input image and the text caption, wherein a higher score means the text caption more accurately describes the image (step S104); ranking the obtained plurality of text captions using the scores (step S106); selecting, from the ranking, a pair of text captions comprising the most accurate text caption and the least accurate text caption (step S108); assigning the selected most accurate text caption as a positive label for the image and assigning the selected least accurate text caption as a negative label for the image (step S110); and adding the image and the assigned positive and negative labels to a database of images with pairs of labels, the database forming the training dataset (step S112).

Thus, the present techniques generally involve generating a set of per-image annotations that will be ranked by a pre-trained CLIP model. The present techniques also involve filtering—described below. The generated training dataset is then used for DPO-based training.

The method of FIG. 2 begins by selecting the set of models to use as annotators and the data to be annotated. To reduce the cost of the generation step, the model used is MobileVLM-v2 given its efficiency and performance. For the data, to avoid introducing any new sources that might bias the results of CLIP-DPO, and to further reduce the method's cost, the initial pool of SFT data used in previous works is used (step S100). Specifically, ShareGPT4v and MobileVLM-v2 may be used as data source as detailed in FIG. 2. In other words, at step S100 of FIG. 2, obtaining a plurality of images may comprise obtaining some or all of the images used to pre-train the first pre-trained large vision-language model.

Ranking (step S106) the obtained plurality of text captions may comprise: determining an image embedding vector for the image, and a text embedding vector for each text caption; and calculating the score for each text caption by determining a similarity between the image embedding vector and the text embedding vector for the text caption. In this way, the image and text captions can be compared more easily, because each is reduced to an embedding that can be compared mathematically.

Calculating a score for each text caption may comprise determining a cosine similarity between the image embedding vector and the text embedding vector for the text caption.

There may be multiple ways to calculate the score for each text caption. One way involves using a contrastively pre-trained Vision-Language model. One example of a contrastively pre-trained vision-language model is CLIP. Thus, the image and the plurality of text captions generated for the image (or their embeddings) may be input into a separate CLIP model to be scored. CLIP provide a score between 0 and 1 between a text caption and an image—the higher the score, the more similar the image and text caption are. The CLIP model does not assess whether the text captions contain hallucinations or inaccuracies—it only compares the inputs and provides a similarity score. However, it has been found that the higher the similarity score, the fewer the hallucinations in the text captions, which makes the score a good way to rank the generated text captions. It will be understood that any vision-language model capable of providing a similarity score between an image-text caption pair (or their embeddings) can be used as the model that performs the scoring and ranking and CLIP is just one example.

At step S104 of FIG. 2, there may be at least two ways to obtaining the plurality of text captions for an image. One way is to generate generic captions for an image, which are general descriptions of the content of the image. For example, a generic caption for an image may say “The image shows a man wearing a suit. He is sitting on steps, and checking his watch”. Another way is to generate image-specific/per-image questions and answers, which are questions and answers specific to the image. For example, a question for an image may be “Is the man wearing jeans?” and the answer may be “No, he is wearing a business suit”. These two ways are now described in turn. The present techniques use one or both of these two ways.

Generation of Generic Captions: The present techniques may begin by generating a set (e.g. five) descriptive captions per image. For each of the MobileVLM-v2 models, at least two prompts (e.g. “identify the setting and note any characters or objects, focusing on visible details.”) may be used to increase the diversity of the generated captions. Two or more pre-defined caption prompts may be used to generate the plurality of text captions. In some cases, one prompt leads to one text caption. That is, the model generates different descriptions of the same image when provided with different prompts that elicit different behaviours in the model during the text caption generation. In other cases, it may be possible for one prompt to lead to more than one text caption.

When exploring other models, it was found that beam search produces captions that are sufficiently diverse for the present purposes. While these captions can be used for ranking and DPO-based training, they are still produced by generic prompts that are not image-specific.

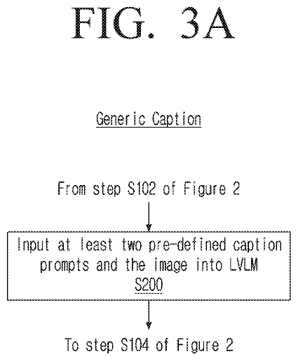

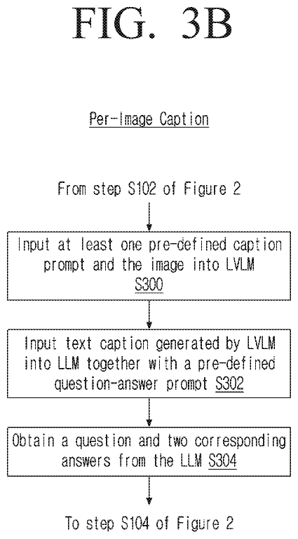

FIG. 3A is a flowchart showing the step to generate a generic caption. As shown, this flowchart stems from when an image is input into a large vision-language model. Thus, step S104 may comprise inputting at least two pre-defined caption prompts into the second pre-trained vision-language ML model together with the image (step S200 of FIG. 3A), wherein the at least two pre-defined prompts cause the pre-trained vision-language ML model to generate the plurality of text captions for the image. The method then returns to step S104 of FIG. 2.

Generation of Per-Image Questions and Answers: To obtain a set of questions per image, an LLM may be leveraged. Specifically, a variant of Mistral-7B Instruct-v0.2 may be used. The generated generic captions may be input into LLM and prompted to generate at least two questions for each image, together with positive and negative answers. The LLM is asked to generate the positive answers based on the input generic captions and to generate plausible but incorrect negative answers given the image description/caption.

FIG. 3B is a flowchart showing the step to generate a per-image caption. As shown, this flowchart stems from when an image is input into a large vision-language model. Thus, step S104 may comprise inputting at least one pre-defined caption prompt into the pre-trained vision-language ML model together with the image (step S300 of FIG. 3B), wherein the at least one pre-defined caption prompt causes the pre-trained vision-language ML model to generate at least one text caption for the image. That is, the per-image captions are generated by first generating at least one generic caption for each image.

Each generic caption is then parsed by a large language model, LLM, into a question, a positive/correct answer and a negative/incorrect answer. Thus, the method further comprises: inputting the generated at least one text caption into a large language model, LLM together with a pre-defined question-answer prompt to generate at least one question with two corresponding answers (step S302 of FIG. 3B); and obtaining, from the LLM, at least one question with two corresponding answers (step S304 of FIG. 3B). The method then returns to step S104 of FIG. 2. That is, the obtained answers are used as the plurality of text captions for the image. LLMs may be the most suitable models for this step, since it is a language processing and conversion step that takes a detailed caption and a prompt that asks the LLM to generate a question, a positive answer, and a negative answer.

The step (S304) of obtaining, from the LLM, at least one question and two corresponding answers may comprise, for each text caption inputted into the LLM: obtaining a positive answer to the question generated by the LLM, wherein the positive answer is a correct answer to the question; and obtaining a negative answer to the question generated by the LLM, wherein the negative answer is an incorrect answer to the question.

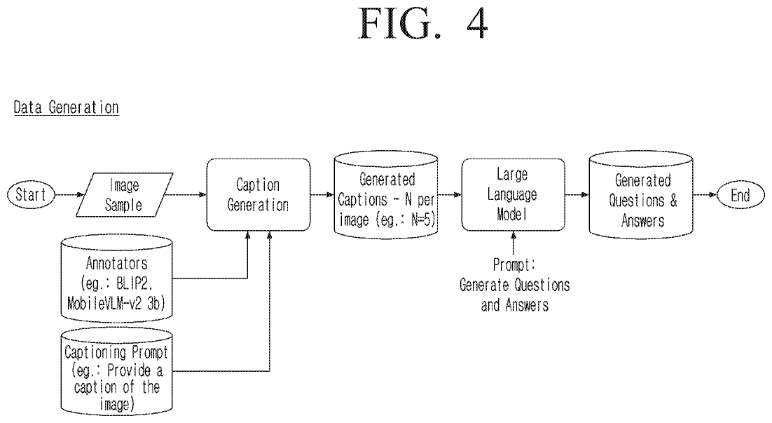

FIG. 4 is a schematic block diagram showing the overall data generation process that involves generating both generic captions and image-specific captions. As shown in FIG. 4, for each image, a plurality of captions are generated (e.g. five per image). Some or all of these generated captions are then input into an LLM, together with prompts, to generate, for each caption, a question and two answers to each question. This leads to the generation of questions and pairs of answers. The generic captions and/or the generated questions and pairs of answers can now be ranked (step S106 in FIG. 2).

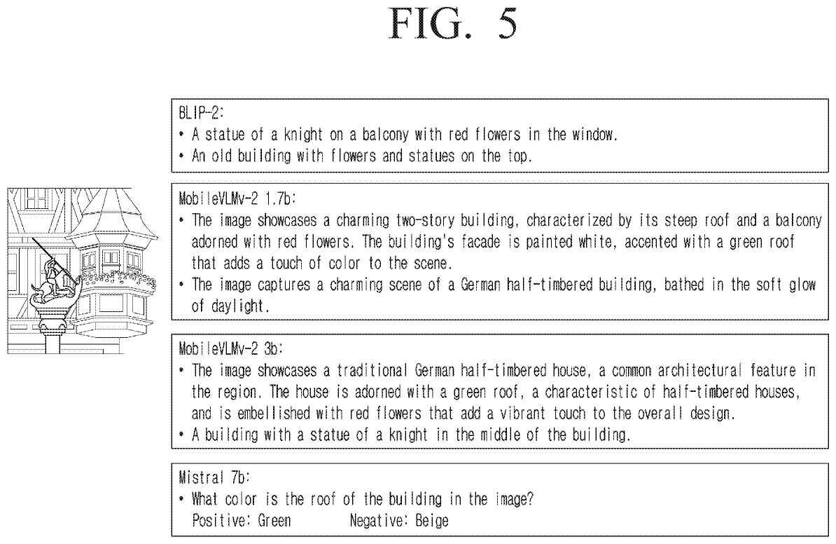

FIG. 5 shows examples of generated generic captions produced by MobileVLM-v2 1.7B, Mobile VLM-v2 3B, and BLIP-2 FlanT5XXL. For MobileVLM-v2 3B's generated caption, the produced question and positive and negative answers generated using Mistral-7B are also shown.

Returning to FIG. 2, as noted above, step S104 comprises receiving a text caption together with a score for the text caption. The scores may be determined using a pre-trained CLIP model to compute the cosine similarity for each produced image-caption pair (an image will have multiple captions). By ranking the scores, it is possible to form positive-negative pairs for DPO training. As not all pairs are however useful (e.g. many of them are easy), a filtering strategy is used before performing the DPO optimization to further accelerate and facilitate the training.

Thus, it may be desirable to filter out possible pairs of text captions that are not useful for forming the training dataset, so that they cannot be selected. There may be two ways to filter out the possible pairs of text captions: global filtering, which involves filtering/rejecting images and text captions that are deemed to be of low quality, and pair filtering, which involves filtering per-image text caption pairs that are not useful. These two ways are now described in turn. The present techniques use one or both of these two ways.

Global filtering: First, it is desirable to keep the highest quality generated data with respect to image-text CLIP scores. One type of global filtering may comprise performing some image filtering after obtaining the plurality of images. This may be useful because the plurality of images may not all be useful. For example, it may be useful to ensure the images used to generate the training dataset are diverse, which may involve not having too many images that are similar to one another, or having too many images that show a certain object or scene.

To this end, the filtering involves analysing the types of images from the images that are obtained from the pre-training of the first pre-trained large vision-language model. To this end, a set of generic categories are defined, e.g. “images of text”, “people”, “objects”, and “scenes”. To assign each image to one of these categories, CLIP is leveraged and a set of (e.g. ten) descriptions per category are generated to create class prototypes. In this case, four class prototypes are created for the four generic categories mentioned above. Then, each image is assigned to one of the four prototypes based on which prototype is the best match (e.g. having the highest cosine similarity). All generic captions below a given CLIP score (i.e. <28.0) are discarded/filtered out.

That is, to down-sample or reduce the number of images, after ranking the obtained plurality of text captions (step S106 in FIG. 2) and prior to the selecting (step S108), the method may further comprise: obtaining a plurality of pre-defined class prototypes, each class prototype representing a type of image content, and each class prototype having a text embedding vector; and discarding any text caption and the image associated with the text caption when the text caption is dissimilar to any of the class prototypes. The pre-defined class prototypes may be generated for generic categories of image content, for example, “text”, “people”, “objects”, and “scenes”. It will be understood that these are example, non-limiting possible categories. For each category, a plurality of text descriptions are generated, which explain what images in the categories may contain. These are then used to create a single class prototype for each category, the prototype comprising a text embedding vector. The class prototypes are used to filter out/discard any text captions, and their associated images, which do not fit in with or suitably match any of the prototypes.

The discarding comprises, for each text caption: calculating a text embedding vector for the text caption; calculating a similarity score between the text embedding vector for the text caption and the text embedding vector of each class prototype; determining, using the calculated similarity score, one class prototype from the obtained plurality of pre-defined class prototypes that best matches the text caption; and discarding the text caption and the image associated with the text caption when the similarity score is below a pre-defined threshold similarity score for the class prototype. Thus, each class prototype may be associated with a pre-defined threshold similarity score. In some cases, all of the class prototypes may be associated with the same pre-defined threshold similarity score. When the similarity score between a text caption and the best-matching class prototype is below the threshold similarity score, the text caption is not considered to be useful or good enough to form part of the final training dataset. In this way, text captions, and their associated images, are discarded.

Another type of global filtering comprises filtering all generic captions that have a score below a certain pre-defined score. This may indicate that the text caption is not very good or even plausible for the image. It is desirable for the negative text captions to be plausible and not obviously wrong. For example, for an image showing a man in a business suit in an office, a caption that says “a mountain scene” is clearly wrong and not even plausible for the image. This is not a useful text caption to use as a positive or negative text caption. Thus, after ranking the obtained plurality of text captions and prior to the selecting, the method may further comprise: discarding any text caption having a score below a pre-defined threshold score. For example, all generic text captions having a CLIP score below 28.0 may be discarded.

Additionally, given that CLIP is trained mainly on short text, long captions are removed to make the CLIP scores more precise. Thus, the global filtering may comprise (after ranking the obtained plurality of text captions and prior to the selecting): discarding any text caption having a length over a pre-defined text caption length. As CLIP may be used to perform the scoring of text captions, given that CLIP is trained mainly on short text, long captions are removed to make the CLIP scores more precise.

With respect to the per-image question-answers, these may also be globally filtered. Their CLIP scores may be calculated and all questions with low CLIP scores (e.g. <25.0) may be removed. This enables generic questions to be removed (e.g. “What is the main object in the image?”) that are already covered by the generated generic captions.

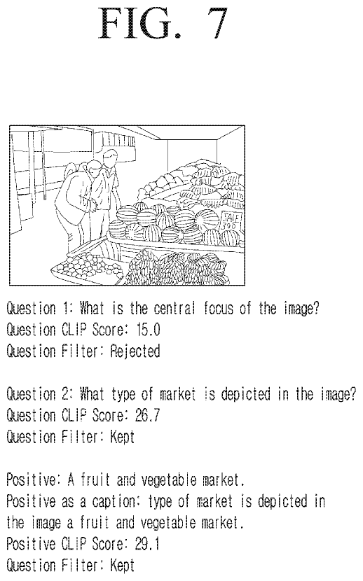

Pair Filtering: Given the remaining high-quality image captions and image question-answers, the final step is to generate a set of positive and negative pairs for DPO training. For the questions, since there is already a set of positive and negative responses generated by the LLM, the pairs that are of low quality are filtered out. To this end, simple regex matching rules may be used to extract an image description from the question and then append the positive answer to it to get a synthetic caption. While these are correct linguistically, the CLIP text encoder flexibility may be leveraged to compute the image-text scores. Then, the examples having low scores are discarded/filtered out. FIG. 7 shows an example of the question filtering procedure. A sample is rejected if the CLIP image-question score is low for a given sample. If the question is relevant and not generic, it is kept. Next, the quality of the answer is evaluated by parsing the question into a caption, appending the positive answer to it, and computing its CLIP score. If the score is high, the sample is kept.

Returning to FIG. 2, at step S108 selecting the pair of text captions may comprise: forming pairs of text captions from the obtained plurality of text captions; and discarding each pair of text captions where the length of the text captions is different. This is useful because it avoids introducing false preferences (e.g. preferring short captions over longer ones) and encourages the focus to be on understanding the difference in the meaning of positive and negative captions.

The method may further comprise: determining, for each pair, whether a difference between scores for each text caption in the pair is above a pre-defined difference threshold indicating that the text captions in each pair are different; and selecting, the pair of text captions having the biggest difference between scores. This is useful because it ensures that the text captions are different enough to form a useful positive and negative pair.

The pair filtering may comprise filtering out all possible pairs of text captions where the CLIP score difference between two captions is lower than a given threshold (e.g. <2.0).

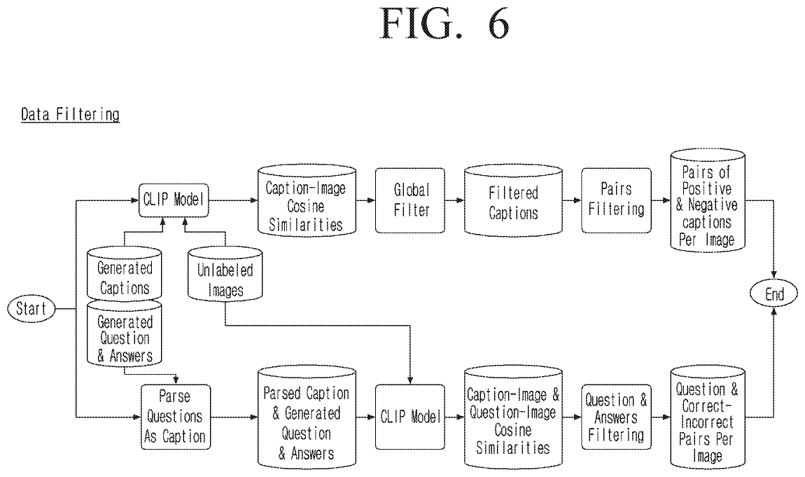

FIG. 6 is a schematic block diagram showing the filtering and pair generation process that follows after captions have been generated (this follows from FIG. 4). As shown in FIG. 6, both generic captions and the questions and answers are filtered. The generic captions are filtered by applying a global filter and then applying the pair filtering. The questions and answers are filtered by applying the pair filtering to remove pairs of positive and negative answers that are of low quality.

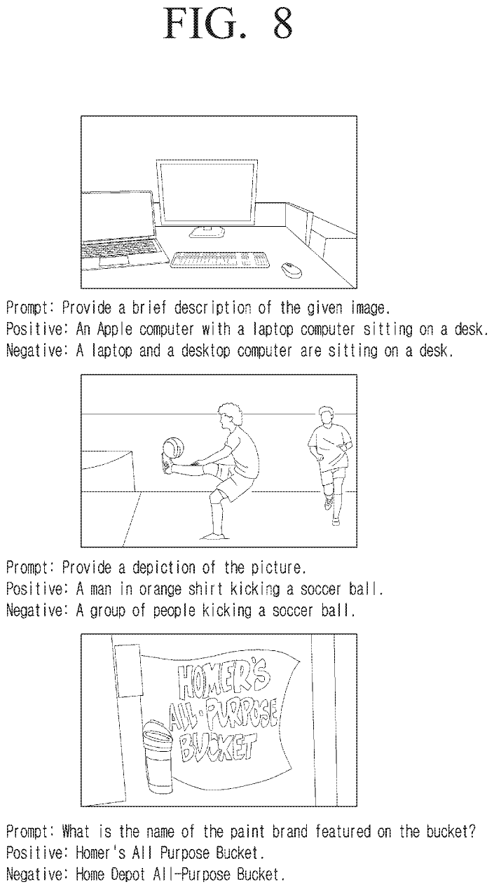

The ranking step at step S106 of FIG. 2 may comprise ordering the possible pairs based on the CLIP score difference between the positive and negative captions in each pair, and then the selecting step at step S108 may comprise selecting the first ranking pair per image. FIG. 8 shows examples of obtained pairs post-filtering.

Network architecture: The present techniques consider two LVLMs architectures—Mobile VLM-v2 and LLaVA-1.5. Both models follow the same overall structure: a pre-trained CLIP vision encoder and a pre-trained LLM. The visual tokens produced by the frozen vision encoder are projected using a small neural network and passed as input to the LLM. LLaVA opts for a pre-trained Vicuna LLM while MobileVLM-v2 uses a MobileLLaMA model, except for their 7B variant, which also uses a Vicuna model. Both share the same ViTL-14 @336px encoder. For efficiency purposes, MobileVLM-v2 uses a lighter projection network, also halving the number of visual tokens. The following model variants were used in the comparisons: MobileVLM-v2-1.7B, Mobile VLMv2-3B, MobileVLM-v2-7B, and LLaVA-1.5 (7B). For scoring the data, ViT-DFN is used for the final version.

Training details: For all the experiments, unless otherwise specified, training starts from the pre-trained MobileVLM-v2 and LLaVA-1.5 models. The models are then fine-tuned for 1 epoch using CLIP-DPO on the constructed dataset. The following hyper-parameters are used for fine-tuning the models: AdamW optimizer with a learning rate of 2e-7, decreased to 0 using a cosine scheduler with warm-up (0.01). The weight decay was set to 0, and the batch size to 256. Both during training and testing, the input images are cropped and resized to 336×336px. The training was performed on 8 A100 GPUs using Pytorch. For larger models, to fit them in memory, the Zero-3 strategy is used.

Results: CLIP-DPO fine-tuning was applied on top of two state-of-the-art models: the MobileVLM-v2 family of models (3 models in total) and LlaVA-1.5. It is found that, in both cases, the present techniques are effective in reducing hallucinations, outperforming all baseline models (i.e. the models without CLIP-DPO fine-tuning) by a significant margin. Importantly, CLIP-DPO significantly outperforms HA-DPO, outperforms Qwen-VL trained on significantly larger datasets (1.4B image-text pairs for pre-training and 77 M for multitask training; as opposed to CLIP-DPO training on just 0.7 M samples), and even matches the performance of GPT-4V without using any GPT-4V model outputs during training. Finally, the enhanced object grounding capabilities of the present model are also illustrated for zero-shot image classification, and it is verified that the present optimization does not degrade the original performance of the base LVLM model.

The present model is evaluated regarding its effectiveness in reducing hallucinations on the recently introduced AMBER benchmark. Moreover, the enhanced grounding capabilities are demonstrated by reporting zero-shot image classification. Finally, it is shown that the proposed CLIP-DPO training does not compromise LVLM performance by reporting results on the LLaVA benchmark.

Evaluation on hallucinations: This section evaluates CLIP-DPO in terms of LVLM hallucination reduction, which is the main objective. The currently most comprehensive and high-quality benchmark, AMBER, is used as an LLM-free multi-dimensional benchmark for LVLM hallucination evaluation, which can be used to evaluate both generative and discriminative tasks including existence, attributes, and relation hallucinations. AMBER first collects and then manually annotates a balanced set of images. Each image is manually labelled (i.e. by humans) with four types of “content”: existence (i.e. covering both foreground and background objects), attributes (state, action, and numbering), relation and hallucinatory target objects (i.e. objects that are not present but are likely to be predicted given the input image). The dataset measures both generative and discriminative forms of hallucination. The generative component prompts the model to describe the image, and the following metrics are computed using the model's output: CHAIR (frequency of imaginary objects), Cover (object coverage of the responses), Hal (proportion of objects with at least one hallucinatory object) and Cog (assesses wherever the hallucinations match those of human cognition). For the discriminative case, the model is prompted with a question, expecting a Yes/No answer. Hence, for the latter, standard classification metrics are reported: accuracy, precision, recall, and F1 score. Finally, the AMBER score combines CHAIR with the F1 value.

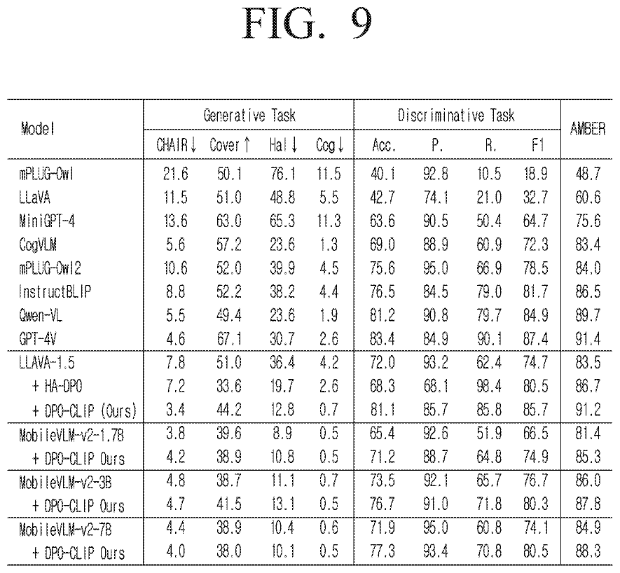

FIG. 9 is a table showing hallucination evaluation results on AMBER for both generative (leftmost set of columns) and discriminative tasks (rightmost set of columns). The present techniques (“DPO-CLIP Ours”) offers consistent and large performance improvements across four different LVLM models and also beats HA-DPO by a large margin.

As the results from FIG. 9 show, Mobile VLM-v2 trained with CLIP-DPO improves upon MobileVLM-v2 baselines across all model sizes, and sometimes quite significantly, especially for the 1.7B and 7B models. It can also be seen that CLIP-DPO significantly improves when applied on top of LLaVA-1.5. Importantly, CLIP-DPO significantly outperforms HA-DPO, the main competing approach, improving the AMBER score 3.2 vs 7.8 when using LLaVA-1.5. Finally, the LlaVA1.5+CLIP-DPO even outperforms Qwen-VL, which is trained on significantly larger datasets (1.4B image-text pairs for pre-training and 77 M for multitask training while CLIP-DPO is fine-tuned on just 0.7 M samples), and even matches the performance of GPT-4V without using any GPT-4V model outputs during training. Overall, these results on a high-quality state-of-the-art benchmark such as AMBER clearly demonstrate the effectiveness of the present CLIP-DPO approach for reducing hallucinations.

Zero-shot image classification: A primary reason for the hallucinatory behaviour of LVLMs is the weak alignment between their visual features and the input LLM tokens. A direct way to evaluate this is through simple zero-shot image classification, which is the go-to benchmark for contrastively trained VL models like CLIP. The typical setup follows a closed-set classification problem, where the names of all possible classes are known a priori. Herein, the same protocol is followed with the notable difference that, as the model is generative, the generated text may contain additional details, synonyms, etc., and hence, it requires a post-processing step for the purpose of evaluation. To avoid complex and error-prone parsing-based approaches, the text encoder of a pre-trained CLIP model is used to obtain a score between the LVLM's output and the names of the image classes. SigLIP was used, although other text encoders were used and performed similarly. Note that prior evaluations of LVLMs for image recognition are limited, as they were shown to have weak zero-shot abilities on this task compared to contrastively-trained VL models.

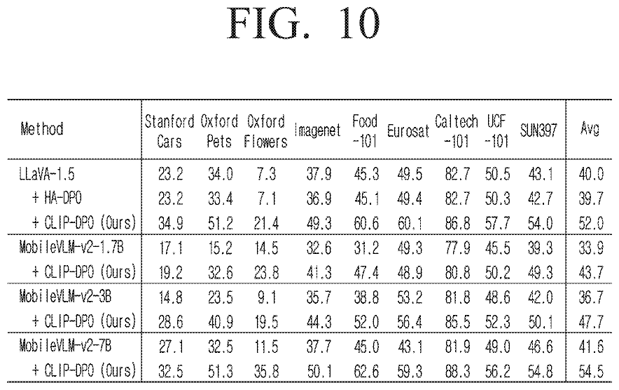

The present techniques are evaluated on a suite of nine diverse datasets: UCF-101, SUN397, Stanford Cars, Oxford Pets, Oxford flowers, ImageNet, Food 101, Eurosat and Caltech-101. FIG. 10 is a table showing results of zero-shot image recognition experiments, in terms of Top-1 accuracy (%). While HA-DPO shows very similar performance to the base model, CLIP-DPO improves the base model by a very large margin in all cases.

As the results from FIG. 10 show, all LVLMs fine-tuned with CLIP-DPO significantly outperform their corresponding baselines, showcasing the increased discriminative properties. Note again that these improvements are obtained without affecting the model's performance on other tasks and datasets.

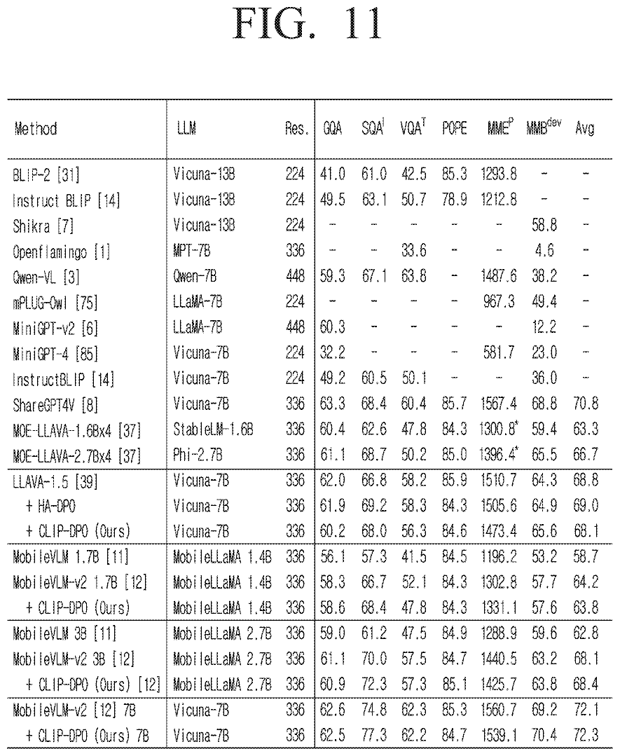

Additional evaluations: Herein, the impact of CLIP-DPO training on other vision language tasks is evaluated and, more specifically, on the popular LLaVA-Bench (GQA, ScienceQA, TextVQA, MME, MMBench). FIG. 11 is a table of results on several vision language tasks from the LlaVA benchmark. The present approach is combined with LVLMs of different sizes, showing consistent performance in all cases. As FIG. 11 shows, overall, CLIP-DPO training does not compromise performance. It is further noted that accuracy improvements on LLaVA-Bench are heavily tied to the addition of extra training data or architectural changes. As the present techniques do not use any additional data and models nor make architectural changes, it is not surprising that the performance after CLIP-DPO training remains largely in line with that of the original baseline model.

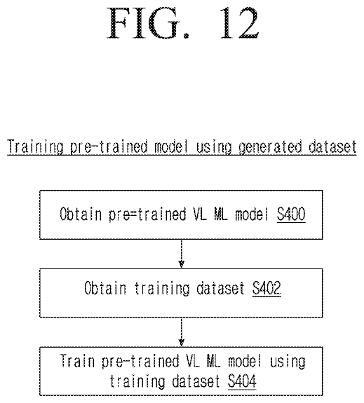

FIG. 12 is a flowchart of example steps to train a pre-trained vision-language, VL model to produce outputs with fewer hallucinations. The method comprises: obtaining a pre-trained large vision-language model (step S400); obtaining a training dataset generated using the methods described herein (e.g. with respect to FIG. 2) (step S402); and further training the pre-trained large vision-language model using the obtained training dataset (step S404).

Step S404 may comprise: generating, for each image of the obtained training dataset, a positive label for the image and a negative label for the image; comparing the generated positive label and negative label with the assigned positive and negative labels of the image to generate a loss; and training the pre-trained large vision-language model to minimise the loss.

The method may be performed by a server. The output of the method is a fine-tuned large vision-language model. The fine-tuned large vision-language model may be used to provide a variety of different user applications.

One such application is a visual chatbot. A user may query a visual chatbot with an image and a set of questions or text queries. The fine-tuned large vision-language model which powers the visual chatbot may produce a set of textual responses to the user's queries. The image input into the chatbot may be a screenshot, an image captured using a camera, a video or the content of a webpage. For example, the chatbot could be used to answer user queries about a webpage they are currently viewing.

Another application is to perform information retrieval and summarisation. Given a set of personal notes and documents, containing both images and text (e.g. PowerPoint presentations, handwritten notes, notes on a phone, simple text files, etc), a user can ask the fine-tuned large vision-language model, via a chat interface, open-ended questions about the content of the notes and documents. This could help the user efficiently consume content and find data in a multi-modal setting, using natural language interactions.

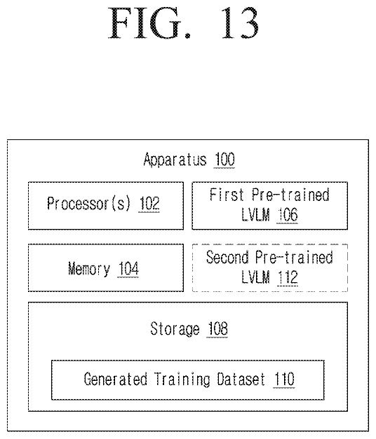

FIG. 13 is a block diagram of an apparatus 100 for generating a training dataset for fine-tuning a first pre-trained large vision-language model 106 to generate accurate text captions, the apparatus 100 comprising: at least one processor 102 coupled to memory 104, arranged for: obtaining a plurality of images; for each image of the plurality of images: inputting the image into a second pre-trained large vision-language model 112 that is pre-trained to output text captions for images; obtaining a plurality of text captions for the image from the second pre-trained large vision-language model together with a score for each text caption that indicates a similarity between the input image and the text caption, wherein a higher score means the text caption more accurately describes the image; ranking the obtained plurality of text captions using the scores; selecting, from the ranking, a pair of text captions comprising the most accurate text caption and the least accurate text caption; assigning the selected most accurate text caption as a positive label for the image and assigning the selected least accurate text caption as a negative label for the image; and adding the image and the assigned positive and negative labels to a database 110 of images with pairs of labels, the database forming the training dataset. The apparatus 100 may comprise storage 108 in which the database/generated training dataset 110 is stored.

Generally speaking, the first pre-trained large vision-language model 106 and the second pre-trained large vision-language model 112 may be the same model. That is, after the first pre-trained large vision-language model has been pre-trained, it may be used to generate the training dataset that will be used to perform its own fine-tuning.

Alternatively, the first pre-trained large vision-language model 106 and the second pre-trained large vision-language model 112 may be different, separate models. That is, a different large vision-language model may be used to generate the training dataset that will be used to perform the fine-tuning of the first pre-trained large vision-language model.

In some cases, the training dataset generation method may be performed on a central server, and thus the apparatus 100 may be a server. In other cases, the training dataset generation method may be performed on end-user devices. In such cases, the apparatus 100 may be a constrained-resource device, but which has the minimum hardware capabilities to use a trained neural network/ML model. The apparatus may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge or smart vacuum cleaner). It will be understood that this is a non-exhaustive and non-limiting list of example apparatuses.

As noted above, the apparatus comprises at least one processor 102 and memory 104. The memory may store instructions that, when executed by the at least one processor individually or collectively, cause the at least one processor to perform the above-described steps.

### REFERENCES

CLIP—Radford, A., Kim, J. W., Hallacy, C., Ramesh, A., Goh, G., Agarwal, S., Sastry, G., Askell, A., Mishkin, P., Clark, J., et al.: Learning transferable visual models from natural language supervision. In: International conference on machine learning. pp. 8748-8763. PMLR (2021)
Zhao Z et al—Zhao, Z., Wang, B., Ouyang, L., Dong, X., Wang, J., He, C.: Beyond hallucinations: Enhancing LVLMs through hallucination-aware direct preference optimization. arXiv preprint arXiv:2311.16839
AMBER—Wang, J., Wang, Y., Xu, G., Zhang, J., Gu, Y., Jia, H., Yan, M., Zhang, J., Sang, J.: An LLM-free multi-dimensional benchmark for MLLMs hallucination evaluation. arXiv preprint arXiv:2311.07397 (2023)
DPO—Rafailov, R., Sharma, A., Mitchell, E., Manning, C. D., Ermon, S., Finn, C.: Direct preference optimization: Your language model is secretly a reward model. Advances in Neural Information Processing Systems 36 (2024)
LLAVA—Liu, H., Li, C., Wu, Q., Lee, Y. J.: Visual instruction tuning. Advances in neural information processing systems 36 (2024)
SIGLIP—Xiaohua Zhai, Basil Mustafa, Alexander Kolesnikov, Lucas Beyer: Sigmoid Loss for Language Image Pre-Training
UCF-101—Khurram Soomro, Amir Roshan Zamir, Mubarak Shah: UCF101: A Dataset of 101 Human Actions Classes From Videos in The Wild
SUN397—Xiao, J., Hays, J., Ehinger, K. A., Oliva, A., Torralba, A.: Sun database: Large-scale scene recognition from abbey to zoo. In: IEEE Conference on Computer Vision and Pattern Recognition (2010)
Stanford Cars—Krause, J., Stark, M., Deng, J., Fei-Fei, L.: 3D object representations for finegrained categorization. In: IEEE International Conference on Computer Vision Workshops (2013)
Oxford Pets—Parkhi, O. M., Vedaldi, A., Zisserman, A., Jawahar, C.: Cats and dogs. In: IEEE Conference on Computer Vision and Pattern Recognition (2012)
Oxford flowers—Nilsback, M. E., Zisserman, A.: Automated flower classification over a large number of classes. In: Indian conference on computer vision, graphics & image processing. pp. 722-729 (2008)
ImageNet—Dai, W., Li, J., Li, D., Tiong, A. M. H., Zhao, J., Wang, W., Li, B., Fung, P., Hoi, S.: InstructBLIP: Towards general-purpose vision-language models with instruction tuning. arXiv preprint arXiv:2305.06500 (2023)
Food 101—Bossard, L., Guillaumin, M., Van Gool, L.: Food-101-mining discriminative components with random forests. In: European Conference on Computer Vision (2014)
Eurosat—Helber, P., Bischke, B., Dengel, A., Borth, D.: EuroSAT: A novel dataset and deep learning benchmark for land use and land cover classification. IEEE Journal of Selected Topics in Applied Earth Observations and Remote Sensing 12(7), 2217-2226 (2019)
Caltech-101—Fei-Fei, L., Fergus, R., Perona, P.: Learning generative visual models from few training examples: An incremental Bayesian approach tested on 101 object categories. In: IEEE Conference on Computer Vision and Pattern Recognition—Workshops (2004)
GQA—Hudson, D. A., Manning, C. D.: Gqa: A new dataset for real-world visual reasoning and compositional question answering. In: IEEE Conference on Computer Vision and Pattern Recognition (2019). MobileVLM-v2-Chu, X., Qiao, L., Zhang, X., Xu, S., Wei, F., Yang, Y., Sun, X., Hu, Y., Lin, X., Zhang, B., et al.: Mobilevlm v2: Faster and stronger baseline for vision language model. arXiv preprint arXiv:2402.03766 (2024)
ScienceQA (SQA)—Lu, P., Mishra, S., Xia, T., Qiu, L., Chang, K. W., Zhu, S. C., Tafjord, O., Clark, P., Kalyan, A.: Learn to explain: Multimodal reasoning via thought chains for science question answering. Advances in Neural Information Processing Systems (2022)
VQA—Singh, A., Natarajan, V., Shah, M., Jiang, Y., Chen, X., Batra, D., Parikh, D., Rohrbach, M.: Towards VQA models that can read. In: IEEE Conference on Computer Vision and Pattern Recognition (2019)
POPE—Wang, J., Zhou, Y., Xu, G., Shi, P., Zhao, C., Xu, H., Ye, Q., Yan, M., Zhang, J., Zhu, J., et al.: Evaluation and analysis of hallucination in large vision-language models. arXiv preprint arXiv:2308.15126 (2023)
MME—Fu, C., Chen, P., Shen, Y., Qin, Y., Zhang, M., Lin, X., Yang, J., Zheng, X., Li, K., Sun, X., et al.: Mme: A comprehensive evaluation benchmark for multimodal large language models. arXiv preprint arXiv:2306.13394 (2023)
MMB—Liu, Y., Duan, H., Zhang, Y., Li, B., Zhang, S., Zhao, W., Yuan, Y., Wang, J., He, C., Liu, Z., et al.: MMBench: Is your multi-modal model an all-around player? arXiv preprint arXiv:2307.06281 (2023)
InstructBLIP—Dai, W., Li, J., Li, D., Tiong, A. M. H., Zhao, J., Wang, W., Li, B., Fung, P., Hoi, S.: InstructBLIP: Towards general-purpose vision-language models with instruction tuning. arXiv preprint arXiv:2305.06500 (2023)
Shikra—Chen, K., Zhang, Z., Zeng, W., Zhang, R., Zhu, F., Zhao, R.: Shikra: Unleashing multimodal llm's referential dialogue magic. arXiv preprint arXiv:2306.15195 (2023) 3
Openflamingo—Awadalla, A., Gao, I., Gardner, J., Hessel, J., Hanafy, Y., Zhu, W., Marathe, K., Bitton, Y., Gadre, S., Sagawa, S., et al.: Openflamingo: An open-source framework for training large autoregressive vision-language models. arXiv preprint arXiv:2308.01390 (2023)
Qwen-VL—Bai, J., Bai, S., Yang, S., Wang, S., Tan, S., Wang, P., Lin, J., Zhou, C., Zhou, J.: Qwen-VL: A versatile vision-language model for understanding, localization, text reading, and beyond. arXiv preprint arXiv:2308.12966 (2023)
HA-DPO—Zhao, Z., Wang, B., Ouyang, L., Dong, X., Wang, J., He, C.: Beyond hallucinations: Enhancing LVLMs through hallucination-aware direct preference optimization. arXiv preprint arXiv:2311.16839 (2023)
BLIP-2—Li, J., Li, D., Savarese, S., Hoi, S.: BLIP-2: Bootstrapping language-image pretraining with frozen image encoders and large language models. arXiv preprint arXiv:2301.12597 (2023)
mPLUG-Owl—Ye, Q., Xu, H., Xu, G., Ye, J., Yan, M., Zhou, Y., Wang, J., Hu, A., Shi, P., Shi, Y., et al.: mplug-owl: Modularization empowers large language models with multimodality. arXiv preprint arXiv:2304.14178 (2023)
MiniGPT-v2—Chen, J., Zhu, D., Shen, X., Li, X., Liu, Z., Zhang, P., Krishnamoorthi, R., Chandra, V., Xiong, Y., Elhoseiny, M.: Minigpt-v2: large language model as a unified interface for vision-language multi-task learning. arXiv preprint arXiv:2310.09478 (2023)
MiniGPT-4—Zhu, D., Chen, J., Shen, X., Li, X., Elhoseiny, M.: MiniGPT-4: Enhancing visionlanguage understanding with advanced large language models. arXiv preprint arXiv:2304.10592 (2023)
ShareGPT4V—Chen, L., Li, J., Dong, X., Zhang, P., He, C., Wang, J., Zhao, F., Lin, D.: Sharegpt4v: Improving large multi-modal models with better captions. arXiv preprint arXiv:2311.12793 (2023)
MoE-LLaVA-1.6Bx4 & 2.7Bx4—Lin, B., Tang, Z., Ye, Y., Cui, J., Zhu, B., Jin, P., Zhang, J., Ning, M., Yuan, L.: Moe-llava: Mixture of experts for large vision-language models. arXiv preprint arXiv:2401.15947 (2024)

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for generating a training dataset for fine-tuning a first pre-trained large vision-language model to generate accurate text captions, the method comprising:
obtaining a plurality of images;
for each image of the plurality of images:
inputting the image into a second pre-trained large vision-language model that is pre-trained to output text captions for images;
obtaining a plurality of text captions for the image from the second pre-trained large vision-language model together with a score for each text caption that indicates a similarity between the input image and the text caption, wherein a higher score means the text caption more accurately describes the image;
ranking the obtained plurality of text captions using the scores;
selecting, from the ranking, a pair of text captions comprising the most accurate text caption and the least accurate text caption;
assigning the selected most accurate text caption as a positive label for the image and assigning the selected least accurate text caption as a negative label for the image; and
adding the image and the assigned positive and negative labels to a database of images with pairs of labels, the database forming the training dataset.

2. The method as claimed in claim 1, wherein ranking the obtained plurality of text captions comprises:
determining an image embedding vector for the image, and a text embedding vector for each text caption; and
calculating the score for each text caption by determining a similarity between the image embedding vector and the text embedding vector for the text caption.

3. The method as claimed in claim 2, wherein calculating a score for each text caption comprises determining a cosine similarity between the image embedding vector and the text embedding vector for the text caption.

4. The method as claimed in claim 2, wherein calculating the score for each text caption comprises using a contrastively pre-trained vision-language model.

5. The method as claimed in claim 1, wherein obtaining the plurality of text captions for the image comprises:
inputting at least two pre-defined caption prompts into the second pre-trained vision-language ML model together with the image, wherein the at least two pre-defined caption prompts cause the pre-trained vision-language ML model to generate the plurality of text captions for the image.

6. The method as claimed in claim 1, wherein obtaining the plurality of text captions for the image comprises:
inputting at least one pre-defined caption prompt into the second pre-trained vision-language ML model together with the image, wherein the at least one pre-defined caption prompt causes the pre-trained vision-language ML model to generate at least one text caption for the image.

7. The method as claimed in claim 6, wherein obtaining the plurality of captions for the image from the ML model further comprises:
inputting the generated at least one text caption into a large language model, LLM together with a pre-defined question-answer prompt to generate at least one question with two corresponding answers;
obtaining, from the LLM, at least one question with two corresponding answers; and
using the obtained answers as the plurality of text captions for the image.

8. The method as claimed in claim 7, wherein obtaining, from the LLM, at least one question and two corresponding answers comprises, for each text caption inputted into the LLM:
obtaining a positive answer to the question generated by the LLM, wherein the positive answer is a correct answer to the question; and
obtaining a negative answer to the question generated by the LLM, wherein the negative answer is an incorrect answer to the question.

9. The method as claimed in claim 1, wherein, after ranking the obtained plurality of text captions and prior to the selecting, the method further comprises:
obtaining a plurality of pre-defined class prototypes, each class prototype representing a type of image content, and each class prototype having a text embedding vector; and
discarding any text caption and the image associated with the text caption when the text caption is dissimilar to any of the class prototypes.

10. The method as claimed in claim 9, wherein the discarding comprises, for each text caption:
calculating a text embedding vector for the text caption;
calculating a similarity score between the text embedding vector for the text caption and the text embedding vector of each class prototype;
determining, using the calculated similarity score, one class prototype from the obtained plurality of pre-defined class prototypes that best matches the text caption; and
discarding the text caption and the image associated with the text caption when the similarity score is below a pre-defined threshold similarity score for the class prototype.

11. The method as claimed in claim 1, wherein, after ranking the obtained plurality of text captions and prior to the selecting, the method further comprises:
discarding any text caption having a score below a pre-defined threshold score.

12. The method as claimed in claim 1, after ranking the obtained plurality of text captions and prior to the selecting, further comprising:
discarding any text caption having a length over a pre-defined text caption length.

13. The method as claimed in claim 1, wherein, for each image selecting, from the ranking, the most accurate text caption and the least accurate text caption comprises:
forming pairs of text captions from the obtained plurality of text captions; and
discarding each pair of text captions where the length of the text captions is different.

14. The method as claimed in claim 13 further comprises:
determining, for each pair, whether a difference between scores for each text caption in the pair is above a pre-defined difference threshold indicating that the text captions in each pair are different; and
selecting, the pair of text captions having the biggest difference between scores.

15. An apparatus for generating a training dataset for fine-tuning a first pre-trained large vision-language model to generate accurate text captions, the apparatus comprising:
at least one processor coupled to memory, arranged for:
obtaining a plurality of images;
for each image of the plurality of images:
inputting the image into a second pre-trained large vision-language model that is pre-trained to output text captions for images;
obtaining a plurality of text captions for the image from the second pre-trained large vision-language model together with a score for each text caption that indicates a similarity between the input image and the text caption, wherein a higher score means the text caption more accurately describes the image;
ranking the obtained plurality of text captions using the scores;
selecting, from the ranking, a pair of text captions comprising the most accurate text caption and the least accurate text caption;
assigning the selected most accurate text caption as a positive label for the image and assigning the selected least accurate text caption as a negative label for the image; and
adding the image and the assigned positive and negative labels to a database of images with pairs of labels, the database forming the training dataset.
